(19) United States
(12) Patent Application Publication
(10) Pub. No.: US 2014/0007768 A1
(43) Pub. Date: Jan. 9, 2014

(54) METHOD AND APPARATUS FOR SEPARATING MIXED GAS FEED

(71) Applicants: Leo Jacques Pierre van den Broeke, Delfgauw (NL); Annemieke van de Runstraat, Zoetermeer (NL); Eva Sanchez Fernandez, Leiden (NL); Alexey Volkov, Moscow (RU); Vladimir Volkov, Moscow (RU); Valery Khotimsky, Moscow (RU)

(72) Inventors: Leo Jacques Pierre van den Broeke, Delfgauw (NL); Annemieke van de Runstraat, Zoetermeer (NL); Eva Sanchez Fernandez, Leiden (NL); Alexey Volkov, Moscow (RU); Vladimir Volkov, Moscow (RU); Valery Khotimsky, Moscow (RU)

(73) Assignees: A.V. TOPCHIEV INSTITUTE OF PETROCHEMICAL SYNTHESIS RUSSIAN ACADEMY OF SCIENCES, Moscow (RU); NEDERLANDSE ORGANISATIE VOOR TOEGEPAST-NATUURWETENSCHAPPELIJK ONDERZOEK TNO, Delft (NL)

(21) Appl. No.: 13/979,534

(22) PCT Filed: Jan. 12, 2012
(86) PCT No.: PCT/NL12/50015

§ 371 Date: Sep. 23, 2013

(30) Foreign Application Priority Data
Jan. 14, 2011 (RU) 2011101428

(51) Int. Cl. B01D 53/14

(52) U.S. Cl. CPC B01D 53/1425
USPC 95/169; 95/186; 96/6

(57) ABSTRACT

The invention is directed to a method for separating gases in a mixed gas feed stream, and to an apparatus for carrying out said method. The method of the invention comprises: i) contacting the mixed gas feed stream with an absorption liquid in an absorption column at a pressure of 1 bar or more, said absorption liquid being selective for absorption of one or more gases in the mixed gas feed stream so that part of the gas in the mixed gas feed stream is absorbed by the absorption liquid resulting in a rich absorption liquid; ii) regenerating at least part of the absorption liquid by contacting the rich absorption liquid with a desorption membrane, wherein the pressure at the retentate side of the desorption membrane is at least 1 bar higher than the pressure at the permeate side of the desorption membrane so that at least part of the absorbed gas desorbs from the rich absorption liquid and permeates through the desorption membrane thereby forming a lean absorption liquid; and iii) recycling at least part of the lean absorption liquid to step i) for contacting with the mixed gas feed stream.

The invention is directed to a method for separating gases in a mixed gas feed stream, and to an apparatus for carrying out said method.

Removing specific gases from gas streams is for many processes required in order to purify the gas feed streams or in order to recover specific products. One of the most commonly used technologies is to absorb contaminants (purification) or the desired product (recovery) in a selective absorption liquid.

A commonly known separation problem is the removal of acid contaminants, such as hydrogen sulphide, from gaseous mixtures. For instance, natural gas is often contaminated with high amounts of carbon dioxide and/or hydrogen sulphide (in particular during the later stages of natural gas extraction). The amount of recoverable gas is directly related to the costs of removing these acid gases. Many processes have been developed to remove these acid gases.

As another example, the removal of carbon dioxide from gaseous mixtures (in particular mixtures comprising hydrogen and carbon dioxide) can be mentioned. This includes pre-combustion capture of carbon dioxide which is a form of hydrogen or synthesis gas treatment.

Many absorption liquids can be considered. Suitable absorption liquids include chemical solvents (for which the absorption primarily depends on chemical reactions between the solvent and the gaseous component) as well as physical solvents (for which the absorption relies on the solubility of the gaseous component rather than a chemical reaction with the solvent).

Physical absorption fluids are mostly used at high (partial) absorbent pressure and are typically used in processes based on absorption under high pressure, followed by desorption at low pressure. The mixed gas feed stream is usually contacted with the absorption liquid in a packed or tray absorption column. After absorption of gas by the absorption liquid, the absorption liquid can be regenerated. This is usually accomplished by heating the absorption liquid and/or reducing the pressure, thereby releasing the absorbed gas for possible further processing. This results in high energy requirements, either for solvent heating or for re-pressurising the absorption liquid to the operating pressure in the absorption step. Therefore, the regeneration step is normally energy intensive and causes high operation costs.

Objective of the invention is to provide a method for separating a mixed gas feed stream, which method uses a cost efficient regeneration of the absorption liquid.

The inventors found that this objective can be met by providing a combined absorption and desorption process, wherein the absorption liquid is maintained at elevated pressure.

Accordingly, in a first aspect the invention is directed to a method for separating gases in a mixed gas feed stream comprising
i) contacting the mixed gas feed stream with an absorption liquid in an absorption column and/or a membrane gas absorption unit at a pressure of 1 bar or more, said absorption liquid being selective for absorption of one or more gases in the mixed gas feed stream so that part of the gas in the mixed gas feed stream is absorbed by the absorption liquid resulting in a rich absorption liquid;
ii) regenerating at least part of the absorption liquid by contacting the rich absorption liquid with a desorption membrane, wherein the pressure at the retentate side of the desorption membrane is at least 1 bar higher than the pressure at the permeate side of the desorption membrane so that at least part of the absorbed gas desorbs from the rich absorption liquid and permeates through the desorption membrane thereby forming a lean absorption liquid; and
iii) recycling at least part of the lean absorption liquid to step i) for contacting with the mixed gas feed stream.

The inventors found that this method is highly advantageous. Since the absorption liquid is at a high pressure during both the absorption step as well as during the desorption step, a considerable lower energy consumption is required for maintaining the pressure of the absorption liquid, or possible increasing the pressure of the absorption liquid for the absorption step after regeneration.

Furthermore, the separated gas (i.e. the gas that permeates through the desorption membrane) can be delivered at an elevated pressure. This is highly advantageous, since it allows for lower compression-energy consumption when (re)injecting the separated gas. For instance, storage of separated gas, such as CO₂ (CCS, carbon separation and storage), normally requires a compression in three steps, wherein particularly the first step is highly energy-consuming. This first step represents more than one-third of the costs. If the separated gas can be delivered under pressure, it may be possible to leave out the highly energy-consuming first compression step. Another advantageous example is enhanced oil recovery, which requires pressurised gas (typically in the order of about 100 bar) to be injected in the subsurface near an oil or gas well. The pressurised separated gas resulting from the method of the present invention can be injected in an oil well to force out oil from the well.

The desorption membrane functions as a barrier for the absorption liquid and thus avoids absorption liquid losses by droplets or foam. Not only will this result in a more efficient absorption liquid regeneration, but also avoids the need for replenishing the absorption liquid (or at least the absorption liquid has to be replenished less frequently).

Moreover, in an embodiment the desorption membrane not only functions as a barrier for the absorption liquid, but in addition acts as a barrier for other species present in the rich absorption liquid, thereby improving the purity of the separated gas (i.e. the gas that permeates through the desorption membrane).

The invention, elegantly allows a combination of one or more classical absorption columns (such as packed or tray columns) and/or a membrane gas absorption units with added benefits of membrane gas desorption. Whereas, for instance, WO-A-2006/004400 describes an integrated membrane gas absorption and desorption process, in accordance with the present invention the membrane gas desorption process is combined with one or more classical absorption columns and/or a membrane gas absorption units, thereby providing considerably improved flexibility and robustness to the process. Membrane gas absorption units, and in particular classical absorption columns (such as known from e.g. WO-A-98/51399) further have the advantage of allowing large bulk applications. In addition, the combination of one or more absorption columns and/or a membrane gas absorption units with one or more membrane gas desorption units gives high flexibility in tuning, for instance, the purity of the end-product(s), the separating capacity, etc. This is because the different units can easily be combined in series and/or parallel depending on the specific desires of the person skilled in the art. Examples of such options are given at the end of this document.

US-A-2002/0 014 154 describes a separation process using a membrane contactor in combination with a liquid absorbent. It differs from the present invention in a few aspects. For one, US-A-2002/0 014 154 specifically refers to organic asymmetric membranes whereas the present invention only specifies the characteristics of the membranes, which leaves the type (symmetric or asymmetric, organic or inorganic etc.) open. A second difference is the module itself. US-A-2002/0 014 154 specifies a layered system of gas-membrane-liquid, while the present invention leaves room for optimisation: flat sheet, spiral wound or tubular. Further, in accordance with the present invention the pressure across the membrane is used for driving force for desorption.

The method of the invention is particularly suitable for separating mixed feed gas streams comprising contaminants, such as, but not excluding, carbon dioxide and/or hydrogen sulphide. In one embodiment, the mixed gas feed stream comprises carbon dioxide and hydrogen and at least part of the carbon dioxide permeates through the desorption membrane. However, the method may also be suitable for other separation processes such as olefin/paraffin separation or biogas upgrading (i.e. purification of biomethane by removal of e.g. H₂S and/or CO₂).

The absorption step is performed at a pressure of 1 bar or more, preferably in the range of 1-200 bar, such as at a pressure in the range of 10-100 bar. A higher absolute pressure gives rise to a higher partial pressure, resulting in a higher driving force and higher rich loading of the absorption liquid. Operating the method of the invention at elevated pressure strongly contributes to lower absorption fluid circulation flows and reduced (re)compression costs of the separated gas.

Absorption of gas, such as acid gas, by the absorption liquid can suitably be performed in an absorber, which is preferably a conventional absorption column and/or a membrane gas absorption unit.

The temperature in the absorption column and/or in the membrane gas absorption unit is usually in the range of 10-500° C., preferably in the range of 30-300° C.

The absorption of gas from the mixed gas feed stream is performed by using an absorption liquid. This absorption step can, for instance, be performed in an absorption column that is suitable for high pressure operations. Examples of such absorption columns are packed or tray columns. Such absorption columns are well-known to the person skilled in the art. Normally, the absorption column will be operated in counter-current mode so that, for instance, mixed gas feed enters the column at the bottom and lean absorption liquid enters the column at the top, while purified gas exits the column at the top and rich absorption liquid exits the column at the bottom.

The absorption liquid used is selective for absorption of one or more gases in the mixed gas feed stream. Suitable absorption liquids can be selected by the skilled person on the basis of the components in the mixed gas feed stream.

Many absorption liquids can be considered. Suitable absorption liquids include chemical solvents (for which the absorption primarily depends on chemical reactions between the solvent and the gaseous component) as well as physical solvents (for which the absorption relies on the solubility of the gaseous component rather than a chemical reaction with the solvent). In general, the regeneration heat for physical solvents is much lower as compared to chemical solvents. In addition, they are less corrosive. However, at lower (partial) pressure, chemical reaction is preferred to bind enough of the target compounds (the compounds that are to be separated from the mixed gas feed). Too high circulation of the absorption liquid will have a negative effect on process economics. The absorption liquid choice can be optimised based on temperature and pressure, depending on the situation (in particular the gases involved and the type of desorption membrane used).

Some examples of physical solvent absorption liquids are dimethylether of tetraethylene glycol, N-methyl-2-pyrrolidone, propylene carbonate, and methanol.

Furthermore, the inventors found that ionic liquids are very suitable absorption liquids, in particular for carbon dioxide absorption. Ionic liquids exhibit high carbon dioxide capacities at high temperatures and have good temperature stability. Ionic liquids are, at room temperature, molten salts. The most common ones are based on imidazolium, pyridinium or quaternary ammonium cations. Advantageously, ionic liquids remain liquid up to temperatures of about 300° C. and are non-volatile. These properties make ionic liquids particularly suitable for high temperature gas separation applications. Some examples of ionic liquid absorption liquids are 1-hexyl-3-methylpyridinium bis(trifluoromethylsulphonyl)imide, 1-pentyl-3-methylimidazolium tris(nonafluorobutyl)trifluorophosphate, butyl-trimethylammonium bis(trifluoromethylsulphonyl)imide, and tetrammoniumethylammonium bis(trifluoromethylfulphonyl)imide. In general, ionic liquid absorption liquids based on a tris(pentafluoroethyl) trifluorophosphate (FAP) anion were found to exhibit the best combination of properties for high pressure and temperature CO₂ absorption within this family of solvents.

The absorption liquid is thereafter regenerated by contacting the rich absorption liquid with a desorption membrane. The desorption membrane separates a retentate side of the membrane from a permeate side of the membrane. A pressure difference is maintained such that the pressure at the retentate side of the desorption membrane is at least 1 bar higher than the pressure at the permeate side of the desorption membrane. At the desorption membrane gas desorbs from the rich absorption liquid and permeates through the desorption membrane. The driving force for permeation of the desorbed gas is the lower pressure at the permeate side of the desorption membrane.

During and/or prior to contacting the absorption liquid with the desorption membrane, the rich absorption liquid may be subjected to optional heating. Such heating can further improve the desorption efficiency at the desorption membrane, by increasing the driving force for desorption. The driving force for desorption and permeation can further be improved by applying a flow of strip gas at the permeate side of the desorption membrane.

In accordance with the invention, the desorption membrane is used as a membrane contactor. This means that the desorption membrane functions as an interface between two phases, without having a significant effect on the mass transfer across the membrane. In general, a high flux membrane material is preferred that does not have a large selectivity for the gases that need to be separated. Preferably, the membrane has a flux for liquid-gas separation of 200 l/hr/m²/bar or more (corresponding to a flux for gas-gas separation of 2000 l/hr/m²/bar or more). More preferably, the membrane has a flux for gas-gas separation in the range of 200-4000 l/hr/m²/bar (corresponding to a flux for gas-gas separation of 2000-40000 l/hr/m²/bar).

The desorption membrane preferably stays stable and retains its high flux at the desorption temperature, in contact with the absorption liquid of choice. Furthermore, the desorption membrane preferably shows good barrier properties towards the absorption liquid, even when a significant trans membrane pressure is applied. Accordingly, the pressure of the absorption liquid at the retentate side of the membrane will hardly (or not) be reduced while the absorbed gas is desorbed.

In particular, hydrophobic desorption membranes are preferred, because most absorption liquids are water-based. More preferably hydrophobic high permeable glassy polymer membranes are used. Examples of suitable organic membrane materials include poly(1-trimethylsilyl-1-propyne), poly(4-methyl-2-pentyne), poly(1-trimethylgermyl-1-propyne), poly(vinyltrimethylsilane), and poly(tetrafluoroethylene). The use of some of these membranes in membrane gas desorption has been described in WO-A-2006/004400. These materials were found to be particularly useful in the method of the invention because they exhibit excellent barrier properties against solvents even at elevated temperature and pressure. Furthermore, membranes comprising these materials have excellent flux properties.

In addition, inorganic membranes (such as alumina-based membranes) can be applied. Nevertheless, some inorganic membranes are less compatible with acid gases, such as CO₂ and H₂S.

In an embodiment a spacer material is applied in the membrane desorption unit. Preferably, the spacer material is compatible with the absorption liquid it is emerged in. Spacers are the mesh-type materials in between membrane sheets and membranes and the membrane module walls. These spacers are there to keep the sheets apart and to distribute the fluid across the membrane. In case of a water-based absorption liquid, it is recommended to use a hydrophilic spacer material. In case of a non-water based absorption liquid hydrophobic spacers are recommended.

The method of the invention can be fine-tuned depending on the desired separation by selecting a specific combination of absorption liquid, desorption membrane material(s), absorption temperature, desorption temperature(s), desorption membrane(s) properties, cross-membrane pressure(s) and type of module(s) (tubular, flat sheet or spiral wound). This allows optimisation of the barrier function of the desorption membrane and optimisation of the absorption efficiency of the absorption liquid. Hence, there is a big potential for steering the overall efficiency of the process.

The desorption membrane typically has a thickness in the range of 10-500 μm, such as in the range of 15-300 μm. If desired, a porous support for improving mechanical stability, such as an organic polymer or ceramic support can be applied.

Advantageously, the membranes that are preferred for the invention also suppress solvent evaporation. Evaporated absorption liquid can be taken along by the desorbing gas (such as CO₂ and/or H₂S). In particular when aqueous systems are used, the evaporation of water is highly energy consuming. Such contamination of the desorbing gas with solvent is disadvantageous, because it requires an additional separation step (such as condensation) and it requires a supplementation of lost solvent.

By suppressing solvent evaporation, energy losses due to heat of evaporation can be saved with the process of the invention, while at the same time avoiding the disadvantages of contamination of the desorbing gas with evaporated solvent. In addition, this means that the invention widens the operating window of the separation process, because solvent losses play a much less eminent role, if any. Even solvents that have so far not been investigated due to their high vapour pressures and corresponding evaporation losses may in accordance with the invention be investigated for their potential as absorption solvent for separation for gases such as CO₂ and/or H₂S.

Suitable membranes for suppressing solvent evaporation (in particular water evaporation), for instance, include hydrophobic desorption membranes, such as the hydrophobic high permeable glassy polymer membranes described above.

The trans membrane pressure (i.e. the pressure difference between the retentate side and the permeate side of the desorption membrane) is 1 bar or more. Preferably, a pressure difference across the desorption membrane in the range of 5-150 bar is applied. The pressure at the retentate side of the desorption membrane will normally be in the range of 1-200 bar, preferably in the range of 5-100 bar.

The temperature in the membrane gas desorption unit is usually in the range of 10-500° C., preferably in the range of 30-300° C.

It is possible to apply more than one membrane gas desorption unit. If multiple membrane gas desorption units are applied, then these units may be coupled in series and/or in parallel. Coupling membrane gas desorption units in series can improve the purity of the separated gas (the gas permeating through the desorption membrane), while coupling membrane gas desorption units in parallel may improve the overall capacity.

For example, the rich absorption liquid may first pass a first membrane gas desorption unit where a first desorption step is performed after which the retained absorption liquid with possible remaining absorbed gas may be supplied to one or more subsequent membrane gas desorption unit, optionally after heating the retained adsorption liquid from the first membrane gas desorption unit. Such an embodiment may increase the degree to which gas is desorbed from the absorption liquid before the lean absorption liquid is recycled for absorbing gas from the mixed gas feed stream. Moreover, in accordance with this embodiment a more purified separated gas can be generated, due to the barrier properties of the membrane. Furthermore, it is possible to separately desorb gases that were simultaneously absorbed in the absorber, for example by using two or more different membranes in the membrane gas desorption units. Normally, the second membrane gas desorption unit will be operated at a lower permeate pressure than the first membrane gas desorption unit. However, the trans membrane pressure is usually higher.

When recycling the lean absorption liquid for absorbing gas from the mixed gas feed stream, the lean absorption liquid can optionally be cooled in order to improve the driving force for absorption of gas.

In a preferred embodiment, the rich absorption liquid is heated and the lean absorption liquid is cooled, wherein the heating of the rich absorption liquid is coupled to the cooling of the lean absorption liquid by means of a heat exchanger. This further lowers the required energy input for operating the apparatus carrying out the method of the invention.

This gas separation process has a high flexibility in actual operation. The membrane gas desorber is modular, so addition of extra units is relatively easy. By choosing the membrane and trans membrane pressure, process operation can be tuned to the actual needs. The invention allows an exact balancing of the loading degree and the circulation rate of the absorption liquid to the required energy input.

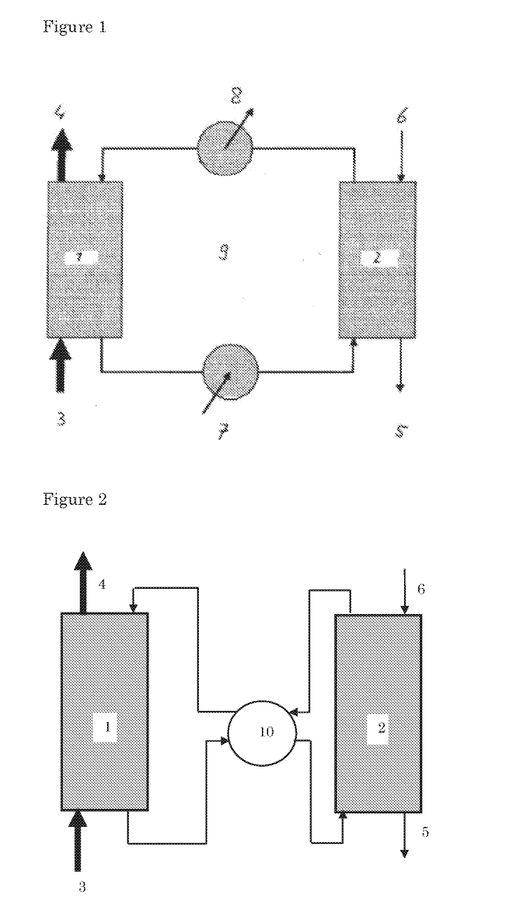

The invention will now be further explained by means of an embodiment wherein carbon dioxide gas is separated from a feed gas mixture of carbon dioxide and hydrogen. This embodiment is further illustrated by FIG. 1, which shows a possible process scheme of the invention.

In FIG. 1, absorption takes place in absorption column (1) where CO₂ is selectively removed from feed gas (3) (e.g. a hydrogen feed gas containing 30 vol. % CO₂) by contact with a selective absorption liquid in circulation loop (9). This results in a purified gas stream (4) (e.g. a hydrogen gas stream containing less than 2 vol. % CO₂). Regeneration of the absorption liquid takes place by feeding the absorption liquid loaded with CO₂ to desorption membrane unit (2). The CO₂ permeates through the desorption membrane and desorbs from the absorption liquid, resulting in CO₂ permeate stream (5) and regenerated absorption liquid. The driving force for the CO₂ permeation is obtained by applying a higher pressure at the retentate side of the desorption membrane than at the permeate side of the desorption membrane. Optionally, heating (7) may be used to increase the driving force for the desorption step in desorption membrane unit (2) or a strip gas (6) may be used for the same purpose. Similarly, cooling (8) may be applied to increase the driving force for the absorption step in absorption column (1).

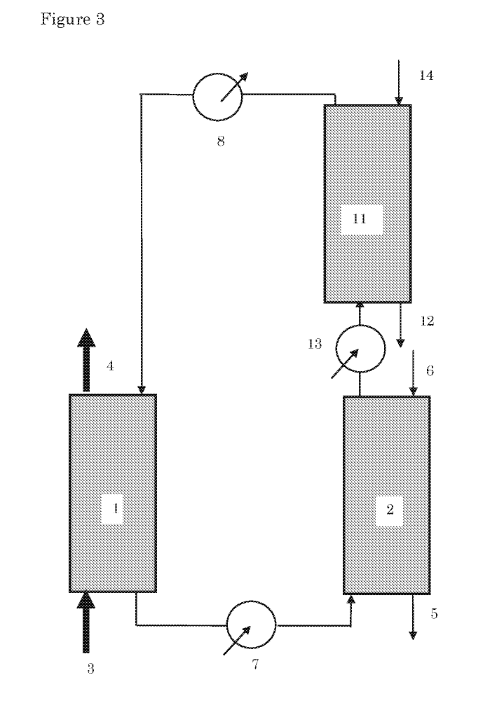

This embodiment shown in FIG. 2 is basically the same as the process shown in FIG. 1. However, heat integration of the solvent streams (7) (optional heating of rich solvent to desorber) and (8) (optional cooling of lean solvent to absorber) is applied. By using a heat exchanger unit (10), both heating and cooling energy can be saved.

FIG. 3 depicts an embodiment based on the base process of FIG. 1 were the regeneration of the solvent is done in two steps. For this purpose, a second desorption membrane unit (11) is introduced in series to the first one. A second gas stream desorbs from the solvent into stream (12). Optionally, heating of the solvent stream (13) a sweep gas stream (14) can be used. In this way, one has the flexibility to desorb to simultaneously absorbed gases or use a second flash at lower pressure to further decrease the absorbed gas. Thus combining a leaner feed solvent for the absorber (1) and obtaining at least part of the desorbed gas at higher pressure.

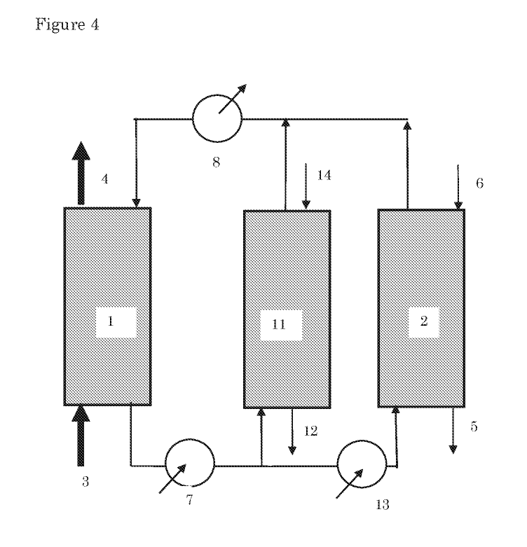

FIG. 4 shows an embodiment wherein a second desorption membrane unit (11) is placed in parallel to the first one. In this case, the rich solvent from the absorber is split into two streams of which then gas is desorbed. The temperatures and permeate side pressures in the two units (2) and (11) can be chosen independently and thus extra flexibility is introduced. This embodiment is thought to be especially advantageous for treating large solvent streams since each of the individual units can be kept small.

Of course it is possible to make any combinations between the embodiments shown in the different Figures.

In a further aspect, the invention is directed to an apparatus for separating gases in a mixed gas feed stream, comprising
an absorption column and/or a membrane gas absorption unit for contacting mixed gas feed stream with an absorption liquid comprising an input for feeding mixed gas feed stream, an input for lean absorption liquid, an output for purified mixed gas, and an output for rich absorption liquid;
a fluid connection for transferring the rich absorption liquid from the absorption column to a regeneration unit, optionally equipped with heating means;
the regeneration unit comprising at least one desorption membrane separating a retentate side of the regeneration unit, in which the rich absorption liquid is supplied, from a permeate side of the regeneration unit, in which gas desorbing from the rich absorption liquid permeates through the desorption membrane; and
a fluid connection for transferring regenerated lean absorption liquid from the regeneration unit to the absorption column, optionally equipped with cooling means,
   wherein the absorption liquid is thus contained in a pressurised closed loop.

In an embodiment, the apparatus comprises a heat exchanger to transfer heat from the rich absorption liquid to the lean absorption liquid. Hence, the fluid connection for transferring rich absorption liquid from the absorption column to the regeneration unit can be coupled to the fluid connection for transferring lean absorption liquid from the regeneration unit to the absorption column by means of a heat exchanger. This further lowers the required energy input for operating the apparatus carrying out the method of the invention.

The invention will be further illustrated by the following Example.

### EXAMPLE

Calculations for H₂/CO₂ separation at 50 bar using the ionic liquid solvent N₄₁₁₁⁺Tf₂N⁻ (butyl-trimethylammonium bis(trifluoromethylsulphonyl) imide) and Teflon AF2400 (amorphous fluoropolymer obtainable from DuPont Fluoropolymers) membranes, show that using a two-step process (Case 2) almost 20% energy can be saved for capturing the same amount of CO₂, relative to a one-step process (Case 1).

Results of the process modelling for the system N₄₁₁₁⁺Tf₂N⁻-Teflon AF2400.

| Overall parameters | | CASE 1 | CASE 2 |
|---|---|---|---|
| Recovery CO₂ | [%] | 80 | 80 |
| Losses of H₂ | [%] | 0.4 | 0.3 |
| Energy per CO₂ avoided | [MJ/kg CO₂] | 4.14 | 3.33 |
| Total required area | [m²] | 21 500 | 20 000 |
| Temperature for Absorption | [° C.] | 40 | 40 |
| Temperature for Desorption | [° C.] | 120 | 60 |
| (stage 1) | | | |
| Temperature for Desorption | [° C.] | NA | 100 |
| (stage 2) | | | |
| Pressure in liquid loop | [bar] | 50 | 50 |
| Pressure of CO₂ gas stream | [bar] | 5 | 5/1 |

1-15. (canceled)

16. A method for separating gases in a mixed gas feed stream comprising:
i) contacting the mixed gas feed stream with an absorption liquid in an absorption column and/or a membrane gas absorption unit at a pressure of 1 bar or more, said absorption liquid being selective for absorption of one or more gases in the mixed gas feed stream so that part of the gas in the mixed gas feed stream is absorbed by the absorption liquid resulting in a rich absorption liquid;
ii) regenerating at least part of the absorption liquid by contacting the rich absorption liquid with a desorption membrane, wherein the pressure at the retentate side of the desorption membrane is at least 1 bar higher than the pressure at the permeate side of the desorption membrane so that at least part of the absorbed gas desorbs from the rich absorption liquid and permeates through the desorption membrane thereby forming a lean absorption liquid; and
iii) recycling at least part of the lean absorption liquid to step i) for contacting with the mixed gas feed stream.

17. The method according to claim 16, wherein the mixed feed gas stream comprises carbon dioxide and/or hydrogen sulphide.

18. The method according to claim 16, wherein the feed gas stream comprises:
i) a mixture of
—CH₄ and
—CO₂ and/or H₂S, or
ii) a mixture of
—H₂ and
—CO₂ and/or H₂₅.

19. The method according to claim 16, wherein the lean absorption liquid is cooled prior to contacting the mixed gas feed stream in step i).

20. The method according to claim 16, wherein a flow of strip gas is applied at the permeate side of the desorption membrane and/or wherein the rich absorption liquid is heated prior to contacting the desorption membrane.

21. The method according to claim 16, wherein the absorption liquid comprises an ionic liquid.

22. The method according to claim 16, wherein the desorption membrane is a barrier for the absorption liquid.

23. The method according to claim 16, wherein the desorption membrane has a thickness of 10-500 μm.

24. The method according to claim 16, wherein the membrane comprises one or more materials selected from the group consisting of poly(1-trimethylsilyl-1-propyne), poly(4-methyl-2-pentyne), poly(1-trimethylgermyl-1-propyne), poly(vinyltrimethylsilane), and poly(tetrafluoroethylene).

25. The method according to claim 16, wherein the pressure at the retentate side of the desorption membrane is in the range of 1-200 bar.

26. The method according to claim 16, wherein the absorption column is a packed or tray absorption column.

27. The method according to claim 16, wherein the absorption liquid with absorbed gas is contacted with the desorption membrane in two or more membrane gas desorption units, connected in series and/or in parallel.

28. The method according to claim 16, wherein part of the gas in the mixed gas feed stream is absorbed by the absorption liquid in step i) across a membrane at elevated pressure.

29. The method according to claim 16, wherein the pressure at the permeate side of the desorption membrane is 5 bar or more.

30. An apparatus for carrying out the method of claim 16, comprising:
an absorption column and/or a membrane gas absorption unit for contacting mixed gas feed stream with an absorption liquid comprising an input for feeding mixed gas feed stream, an input for lean absorption liquid, an output for purified mixed gas, and an output for rich absorption liquid;
a fluid connection for transferring the rich absorption liquid from the absorption column to a regeneration unit, optionally equipped with heating means;
the regeneration unit comprising at least one desorption membrane separating a retentate side of the regeneration unit, in which the rich absorption liquid is supplied, from a permeate side of the regeneration unit, in which gas desorbing from the rich absorption liquid permeates through the desorption membrane; and
a fluid connection for transferring regenerated lean absorption liquid from the regeneration unit to the absorption column, optionally equipped with cooling means, wherein the absorption liquid is contained in a pressurised closed loop.

31. The method of claim 21, wherein the ionic liquid has an imidazolium pyridinium, or quaternary ammonium cation.

32. The method of claim 25, wherein the pressure at the retentate side of the desorption membrane is in the range of 10-100 bar.

33. The method of claim 29, wherein the pressure at the retentate side of the desorption membrane is in the range of 10-100 bar.

34. The method of claim 17, wherein the feed gas stream comprises:
i) a mixture of
—CH₄ and
—CO₂ and/or H₂S, or
ii) a mixture of
—H₂ and
—CO₂ and/or H₂S.

35. The method of claim 17, wherein the lean adsorption liquid is cooled prior to contacting the mixed gas feed stream in step i).
